(19) United States
(12) Patent Application Publication
(10) Pub. No.: US 2023/0346045 A1
(43) Pub. Date: Nov. 2, 2023

(54) VAPORIZER, BATTERY ROD, AND ELECTRONIC VAPORIZATION DEVICE

(71) Applicant: SHENZHEN SMOORE TECHNOLOGY LIMITED, Shenzhen (CN)

(72) Inventors: Wenjie DONG, Shenzhen (CN); Bosong ZHAO, Shenzhen (CN); Weiming FANG, Shenzhen (CN); Ruilong ZHOU, Shenzhen (CN)

(21) Appl. No.: 18/350,681

(22) Filed: Jul. 11, 2023

Related U.S. Application Data
(63) Continuation of application No. PCT/CN2021/074489, filed on Jan. 29, 2021.

(51) Int. Cl. A24F 40/57; A24F 40/42; A24F 40/46

(52) U.S. Cl. CPC A24F 40/57; A24F 40/42; A24F 40/46; A24F 40/10

(57) ABSTRACT

A vaporizer includes: a first connection end and a second connection end, to be connected to a battery rod upon insertion of the vaporizer into the battery rod; and an anti-counterfeiting circuit connected to the first connection end and the second connection end, the anti-counterfeiting circuit being receiving a first communication signal from the battery rod and sending a second communication signal to the battery rod through the first connection end to implement communication between the battery rod and the vaporizer. The first communication signal includes a first level signal serving as a logic high level and a second level signal serving as a logic low level. The second communication signal includes a third level signal serving as a logic high level and a fourth level signal serving as a logic low level. The second level signal and the fourth level signal are greater than a power supply voltage.

### CROSS-REFERENCE TO PRIOR APPLICATION

This application is a continuation of International Patent Application No. PCT/CN2021/074489, filed on Jan. 29, 2021. The entire disclosure is hereby incorporated by reference herein.

### FIELD

This application relates to the field of vaporization technologies, and in particular, to a vaporizer, a battery rod, and an electronic vaporization device.

### BACKGROUND

In an existing electronic vaporization device with an encryption function, a PCB is generally configured on a vaporizer, and a controller, a capacitor, and a MOS transistor is disposed on the PCB to implement the encryption function. In an actual application process, a high-power MOS transistor and/or a large-capacity capacitor are/is generally required for normal operation, but the size of the high-power MOS transistor or the large-capacity capacitor is generally very large, which may significantly increase an area of the PCB and limit the size of the vaporizer.

### SUMMARY

In an embodiment, the present invention provides a vaporizer, comprising: a first connection end and a second connection end, configured to be connected to a battery rod upon insertion of the vaporizer into the battery rod; and an anti-counterfeiting circuit connected to the first connection end and the second connection end, the anti-counterfeiting circuit being configured to receive a first communication signal from the battery rod and to send a second communication signal to the battery rod through the first connection end to implement communication between the battery rod and the vaporizer, wherein the first communication signal comprises a first level signal serving as a logic high level and a second level signal serving as a logic low level, wherein the second communication signal comprises a third level signal serving as a logic high level and a fourth level signal serving as a logic low level, and wherein the second level signal and the fourth level signal are greater than a power supply voltage of the anti-counterfeiting circuit.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a schematic diagram of functional modules of a first embodiment of a vaporizer according to this application;

FIG. 2 is a schematic diagram of functional modules of a first embodiment of a battery rod according to this application;

FIG. 3 is a schematic diagram of functional modules of an electronic vaporization device formed through connection of the vaporizer shown in FIG. 1 and the battery rod shown in FIG. 2;

FIG. 4 is a schematic diagram of waveforms of a first embodiment of a first communication signal and a second communication signal according to this application;

FIG. 5 is a schematic diagram of waveforms of a second embodiment of a first communication signal and a second communication signal according to this application;

FIG. 6 is a schematic diagram of waveforms of a third embodiment of a first communication signal and a second communication signal according to this application;

FIG. 7 is a schematic structural diagram of a first embodiment of the battery rod shown in FIG. 2;

FIG. 8 is a schematic diagram of a waveform of a second communication signal identified by a signal identification unit in FIG. 7;

FIG. 9 is a schematic structural diagram of a second embodiment of the battery rod shown in FIG. 2;

FIG. 10 is a schematic structural diagram of a third embodiment of the battery rod shown in FIG. 2;

FIG. 11 is a schematic structural diagram of a fourth embodiment of the battery rod shown in FIG. 2;

FIG. 12 is a schematic structural diagram of a fifth embodiment of the battery rod shown in FIG. 2;

FIG. 13 is a schematic structural diagram of a sixth embodiment of the battery rod shown in FIG. 2;

FIG. 14 is a schematic structural diagram of a seventh embodiment of the battery rod shown in FIG. 2;

FIG. 15 is a schematic structural diagram of an embodiment of an electronic vaporization device according to this application;

FIG. 16a and FIG. 16b are schematic structural diagrams of a first embodiment of a vaporizer according to this application;

FIG. 17 is a schematic structural diagram of a second embodiment of a vaporizer according to this application;

FIG. 18a and FIG. 18b are schematic structural diagrams of a third embodiment of a vaporizer according to this application;

FIG. 19a and FIG. 19b are schematic structural diagrams of a fourth embodiment of a vaporizer according to this application;

FIG. 20a and FIG. 20b are schematic structural diagrams of a fifth embodiment of a vaporizer according to this application;

FIG. 21 is a schematic structural diagram of a sixth embodiment of a vaporizer according to this application;

FIG. 22a and FIG. 22b are schematic structural diagrams of a seventh embodiment of a vaporizer according to this application;

FIG. 23 is a schematic structural diagram of an eighth embodiment of a vaporizer according to this application;

FIG. 24a and FIG. 24b are schematic structural diagrams of a ninth embodiment of a vaporizer according to this application;

FIG. 25a and FIG. 25b are schematic structural diagrams of a tenth embodiment of a vaporizer according to this application;

FIG. 26 is a schematic structural diagram of an eleventh embodiment of a vaporizer according to this application;

FIG. 27a and FIG. 27b are schematic structural diagrams of a twelfth embodiment of a vaporizer according to this application;

FIG. 28a to FIG. 28c are schematic structural diagrams of a thirteenth embodiment of a vaporizer according to this application.

### DETAILED DESCRIPTION

In an embodiment, the present invention provides a vaporizer, a battery rod, and an electronic vaporization device, which can implement communication between the battery rod and the vaporizer, and further determine whether the battery rod matches the vaporizer.

In an embodiment, the present invention provides a vaporizer, including: a first connection end and a second connection end, configured to be connected to a battery rod when the vaporizer is inserted into the battery rod; and an anti-counterfeiting circuit, connected to the first connection end and the second connection end, where the anti-counterfeiting circuit receives a first communication signal from the battery rod and sends a second communication signal to the battery rod through the first connection end, to implement communication between the battery rod and the vaporizer; the first communication signal includes a first level signal serving as a logic high level and a second level signal serving as a logic low level; the second communication signal includes a third level signal serving as a logic high level and a fourth level signal serving as a logic low level; and the second level signal and the fourth level signal are greater than a power supply voltage of an anti-counterfeiting circuit.

The first level signal is greater than or equal to the third level signal, the fourth level signal is greater than or equal to the second level signal, and the third level signal is greater than the second level signal.

The first level signal is greater than or equal to the third level signal, the fourth level signal is less than or equal to the second level signal, and the third level signal is greater than or equal to the second level signal.

The second level signal is greater than the third level signal.

The anti-counterfeiting circuit includes a signal source, where the signal source is connected to the first connection end and the second connection end, and the signal source works in a first state or a second state to send the second communication signal to the battery rod.

The anti-counterfeiting circuit further includes a processing unit, including a first control interface configured to output a first control signal; and the signal source is connected to the first control interface and works in the first state or the second state under driving of the first control signal.

The vaporizer further includes a heating element, where the heating element is connected to the signal source in parallel, and is connected in parallel between the first connection end and the second connection end; when the signal source works in the first state, a voltage on the first connection end is maintained at the third level signal; and when the signal source works in the second state, the voltage on the first connection end is maintained at the fourth level signal.

The processing unit includes a second control interface configured to output a second control signal; and the vaporizer further includes a direction switching circuit, where the direction switching circuit is connected to the second control interface and is connected to the heating element in parallel, and is configured to implement forward or reverse insertion of the vaporizer into the battery rod under driving of the second control signal.

The anti-counterfeiting circuit is integrated and then encapsulated into an independent element.

To resolve the foregoing technical problem, a second technical solution provided in this application is to provide a battery rod, including: a first connection end and a second connection end, configured to be connected to a vaporizer inserted into the battery rod; and a control unit, connected to the first connection end, to send a first communication signal to the vaporizer inserted into the battery rod and receive a second communication signal from the vaporizer through the first connection end, so as to implement communication between the battery rod and the vaporizer, where the first communication signal includes a first level signal serving as a logic high level and a second level signal serving as a logic low level; the second communication signal includes a third level signal serving as a logic high level and a fourth level signal serving as a logic low level; and the second level signal and the fourth level signal are greater than a power supply voltage of an anti-counterfeiting circuit.

The first level signal is greater than or equal to the third level signal, the fourth level signal is greater than or equal to the second level signal, and the third level signal is greater than the second level signal.

The first level signal is greater than or equal to the third level signal, the fourth level signal is less than or equal to the second level signal, and the third level signal is greater than or equal to the second level signal.

The second level signal is greater than the third level signal.

The battery rod further includes a first voltage unit, connected to the control unit and the first connection end, and configured to send the first level signal to the vaporizer; and a second voltage unit, connected to the control unit and the first connection end, and configured to send the second level signal to the vaporizer.

The first voltage unit includes: a first switch, including a first path end, a second path end, and a control end, where the control end of the first switch is connected to a first driving end of the control unit to receive a first driving signal, the first path end of the first switch receives a battery voltage, and the second path end of the first switch is connected to the first connection end.

The second voltage unit includes: a second switch, including a first path end, a second path end, and a control end, where the control end of the second switch is connected to a second driving end of the control unit to receive a second driving signal, the second driving signal is a PWM signal, and the first path end of the second switch receives the battery voltage; a first resistor, where a first end of the first resistor is connected to the second path end of the second switch, and a second end of the first resistor is connected to the first connection end; and a first capacitor, where a first end of the first capacitor is connected to the second path end of the second switch, and a second end of the first capacitor is grounded.

The battery rod further includes a protection unit, connected to the second voltage unit and the first voltage unit, and configured to prevent a heating signal of the first connection end from being affected in a heating process.

The protection unit includes: a third switch, including a first path end, a second path end, and a control end, where the first path end of the third switch is connected to the second end of the first resistor, the control end of the third switch is connected to the control unit, and the second path end of the third switch is connected to the first connection end; or the protection unit includes: a first diode, where an anode of the first diode is connected to the second end of the first resistor, and a cathode of the first diode is connected to the first connection end.

The second voltage unit includes: a fourth switch, including a first path end, a second path end, and a control end, where the control end of the fourth switch is connected to a second driving end of the control unit to receive a second driving signal, and the first path end of the fourth switch is connected to a power supply management chip to receive a voltage; and a second resistor, where a first end of the second resistor is connected to the second path end of the fourth switch, and a second end of the second resistor is connected to the first connection end.

The second voltage unit includes: a fifth switch, including a first path end, a second path end, and a control end, where the control end of the fifth switch is connected to a second driving end of the control unit to receive a second driving signal, the second driving signal is a PWM signal, and the first path end of the fifth switch receives the battery voltage; a third resistor, where a first end of the third resistor is connected to the second path end of the fifth switch, and a second end of the third resistor is connected to the first connection end; a sixth switch, including a first path end, a second path end, and a control end, where the control end of the sixth switch is connected to a third driving end of the control unit to receive a third driving signal, and the first path end of the sixth switch receives the battery voltage; and a fourth resistor, where a first end of the fourth resistor is connected to the second path end of the sixth switch, and a second end of the fourth resistor is connected to the first connection end.

The second voltage unit includes: a seventh switch, including a first path end, a second path end, and a control end, where the control end of the seventh switch is connected to a second driving end of the control unit to receive a second driving signal, the second driving signal is a level signal, and the first path end of the seventh switch receives the battery voltage; and a fifth resistor, where a first end of the fifth resistor is connected to the second path end of the seventh switch, and a second end of the fifth resistor is connected to the first connection end.

The second voltage unit includes: a first comparator, including a first input end, a second input end, and an output end, where the first input end of the first comparator receives a reference voltage, and the second input end of the first comparator is connected to the first connection end; an eighth switch, including a first path end, a second path end, and a control end, where the control end of the eighth switch is connected to the output end of the first comparator, and the first path end of the eighth switch receives the battery voltage; and a sixth resistor, where a first end of the sixth resistor is connected to the second path end of the eighth switch, and a second end of the sixth resistor is connected to the first connection end.

The battery rod further includes: a signal identification unit, connected to a signal acquisition end of the control unit and the first connection end, and configured to identify the second communication signal and feed back an identification result to the signal acquisition end.

The signal identification unit includes: a second comparator, including a first input end, a second input end, and an output end, where the output end of the second comparator is connected to the signal acquisition end of the control unit.

The signal identification unit includes: an operational amplifier, including a first input end, a second input end, and an output end, where the output end of the operational amplifier is connected to the signal acquisition end of the control unit.

The signal identification unit is an analog-to-digital converter, and the signal identification unit is integrated in the control unit.

To resolve the foregoing technical problem, a third technical solution provided in this application is to provide an electronic vaporization device, including: a vaporizer, where the vaporizer includes the vaporizer according to any one of the foregoing; and a battery rod, where the battery rod includes the battery rod according to any one of the foregoing.

Beneficial effects of this application are different from those in the related art. In a vaporizer of this application, an anti-counterfeiting circuit is disposed, the anti-counterfeiting circuit is connected to a first connection end and a second connection end of the vaporizer, so that the anti-counterfeiting circuit receives a first communication signal from a battery rod and sends a second communication signal to the battery rod through the first connection end, to implement communication between the battery rod and the vaporizer.

The technical solutions in the embodiments of this application are clearly and completely described below with reference to the accompanying drawings in the embodiments of this application. Apparently, the described embodiments are merely some rather than all of the embodiments of this application. All other embodiments obtained by a person of ordinary skill in the art based on the embodiments of this application without creative efforts shall fall within the protection scope of this application.

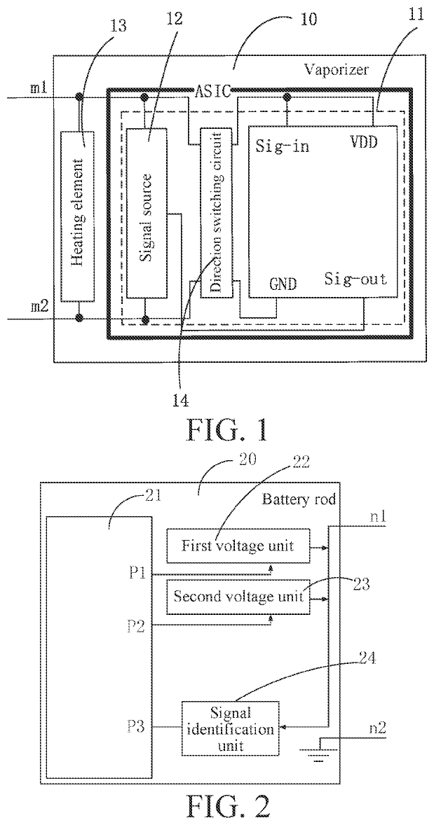

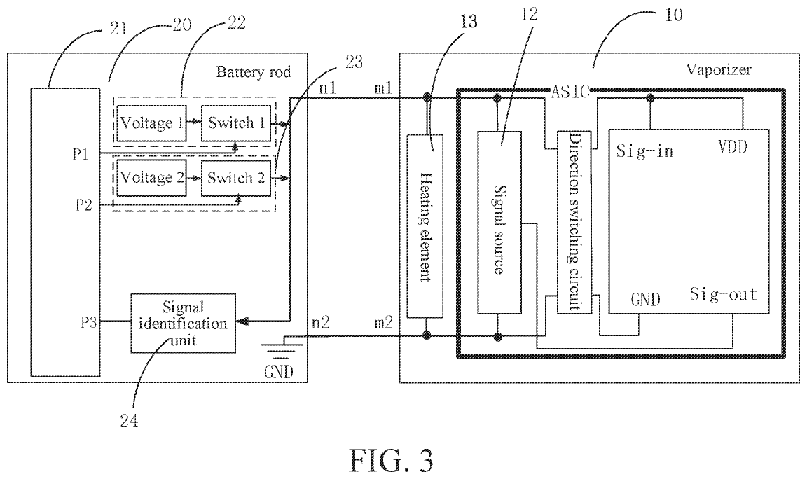

Referring to FIG. 1 and FIG. 2, FIG. 1 is a schematic diagram of functional modules of an embodiment of a vaporizer 10 according to this application, and FIG. 2 is a schematic diagram of functional modules of a first embodiment of a battery rod 20 according to this application. Specifically, the vaporizer 10 includes a first connection end m1 and a second connection end m2. When the vaporizer 10 is inserted into the battery rod 20 to be connected to the battery rod 20, the first connection end m1 and the second connection end m2 are correspondingly connected to a first connection end n1 and a second connection end n2 in the battery rod 20. As shown in FIG. 3, FIG. 3 is a schematic diagram of functional modules of an embodiment of an electronic vaporization device formed through connection of the vaporizer 10 shown in FIG. 1 and the battery rod 20 shown in FIG. 2. It may be understood that, the first connection end m1/n1 and the second connection end m2/n2 corresponding to a positive electrode and a negative electrode of the vaporizer 10/the battery rod 20 respectively.

As shown in FIG. 1, the vaporizer 10 further includes an anti-counterfeiting circuit 11. The anti-counterfeiting circuit 11 is connected to the first connection end m1 and the second connection end m2, and the anti-counterfeiting circuit 11 receives a first communication signal from the battery rod 20 and sends a second communication signal to the battery rod 20 through the first connection end m1, to implement communication between the battery rod 20 and the vaporizer 10. Specifically, when the battery rod 20 is connected to the vaporizer 10, the first connection end m1 of the vaporizer 10 receives the first communication signal from the battery rod 20, and the vaporizer 10 sends the second communication signal to the battery rod 20 through the first connection end m1 after receiving the first communication signal, to implement communication between the battery rod 20 and the vaporizer 10, and further determine whether the battery rod 20 matches the vaporizer 10.

In a specific embodiment, the anti-counterfeiting circuit 11 is integrated on an anti-counterfeiting chip ASIC. In the related art, an encryption function of an electronic vaporization device is implemented through a circuit board, namely, a PCB. However, in an actual application process, a high-power MOS transistor and/or a large-capacity capacitor are/is generally required for normal operation, but the size of the high-power MOS transistor or the large-capacity capacitor is generally very large, which may significantly increase an area of the PCB and limit the size of the vaporizer 10. In addition, due to limitation of the area of the PCB, the assembly difficulty may be increased. In this application, the anti-counterfeiting circuit 11 is integrated on an anti-counterfeiting chip ASIC. The anti-counterfeiting chip ASIC may be a wafer, which has a feature of a small volume and may be independently encapsulated into an independent element. Therefore, the structure of PCB is replaced, to achieve an objective of reducing costs. Further, during assembly, the anti-counterfeiting circuit can be assembled at any position in the vaporizer 10 without being limited by the volume, thereby reducing the assembly difficulty.

The vaporizer 10 further includes a heating element 13. The heating element 13 is connected to the anti-counterfeiting circuit 11 in parallel. Specifically, the heating element 13 is connected to the first connection end m1 and the second connection end m2 of the vaporizer 10. The anti-counterfeiting circuit 11 includes a signal source 12, and the signal source 12 is connected to the first connection end m1 and the second connection end m2. That is, the signal source 12 is connected to the heating element 13 in parallel. The signal source 12 works in a first state or a second state to send the second communication signal to the battery rod 20. In this application, the signal source 12 is disposed on the anti-counterfeiting circuit 11 implementing the encryption function, and the signal source 12 works in the first state or the second state to send the second communication signal to the battery rod 20 to further implement communication between the battery rod 20 and the vaporizer 10. Components such as the high-power MOS transistor, the large-capacity capacitor, and the PCB are not used, and the anti-counterfeiting circuit 11 is integrated on the anti-counterfeiting chip ASIC to form an independent element, so that the size of the vaporizer 10 can be further reduced, thereby reducing costs. Specifically, a main function of the signal source 12 is to generate voltage signals with different amplitudes in two different working states, the signal source 12 specifically may be a constant current source or may be a load, and the load specifically may be a resistor, a transistor, a MOS transistor, or a diode.

Specifically, the anti-counterfeiting circuit 11 further includes a processing unit CPU. The processing unit CPU includes a first control interface Sig-out configured to output a first control signal; and the signal source is 12 is connected to the first control interface Sig-out and works in the first state or the second state under driving of the first control signal.

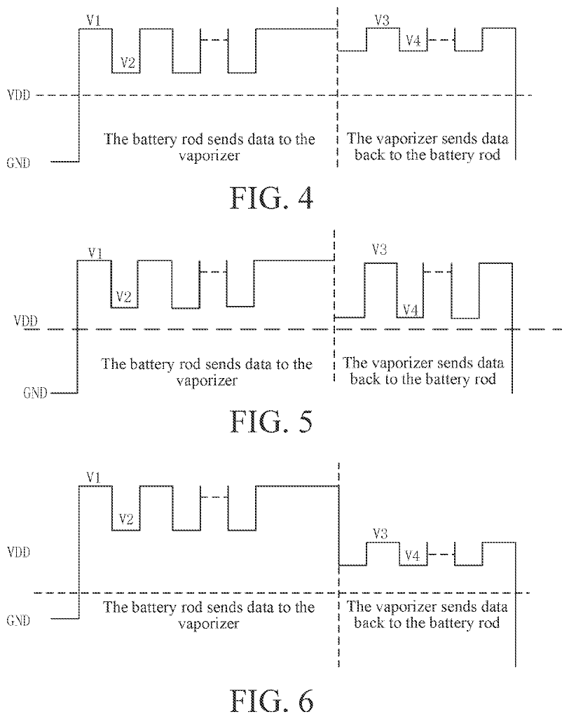

Specifically, after the vaporizer 10 receives the first communication signal, the processing unit CPU outputs the first control signal through the first control interface Sig-out to drive the signal source 12 to work in the first state. In this case, the signal source 12 is in a non-working state. As shown in FIG. 4, FIG. 5, and FIG. 6, a voltage on two ends (namely, the first connection end n1/m1) of the heating element 13 is a third level signal V3 serving as a logic high level, thereby implementing sending of data “1” from the vaporizer 10 to the battery rod 20. The processing unit CPU outputs the first control signal through the first control interface Sig-out to drive the signal source 12 to work in the second state. In this case, the signal source 12 is in a working state, and the signal source 12 is connected to the heating element 13 in parallel. As shown in FIG. 3, a divider voltage between the signal source and internal resistance of a switch 1 in the battery rod 20 is reduced, and a value of the voltage on the two ends (namely, the first connection end n1/m1) of the heating element 13 is reduced. In addition, as shown in FIG. 4, FIG. 5, and FIG. 6, the voltage is a fourth level signal V4 serving as a logic low level, thereby implementing sending of data “0” from the vaporizer 10 to the battery rod 20.

As shown in FIG. 2, the battery rod 20 includes a first connection end n1 and a second connection end n2, configured to be connected to the vaporizer 10 inserted into the battery rod 20. The battery rod 20 further includes a control unit 21, and the control unit 21 is connected to the first connection end n1, to send the first communication signal to the vaporizer 10 inserted into the battery rod 20 through the first connection end n1 and receive the second communication signal from the vaporizer 10 through the first connection end n1, to implement communication between the battery rod 20 and the vaporizer 10. The second communication signal is received when the signal source 12 in the vaporizer 10 works in the first state or the second state. Specifically, when the signal source 12 works in the first state, the signal source 12 does not work. In this case, the voltage on the two ends (namely, the first connection end n1/m1) of the heating element 13 is the third level signal V3 serving as a logic high level, thereby implementing sending of data “1” from the vaporizer 10 to the battery rod 20. When the signal source 12 is driven to work in the second state, the signal source 12 is in a working state, the signal source 12 is connected to the heating element 13 in parallel, the divider voltage between the signal source and the internal resistance of the switch 1 in the battery rod 20 is reduced, and the value of the voltage on the two ends (namely, the first connection end n1/m1) of the heating element 13 is reduced to be the fourth level signal V4 serving as a logic low level, thereby implementing sending of data “0” from the vaporizer 10 to the battery rod 20.

Specifically, as shown in FIG. 4, FIG. 5, and FIG. 6, the first communication signal includes a first level signal V1 serving as a logic high level and a second level signal V2 serving as a logic low level; and the second communication signal includes a third level signal V3 serving as a logic high level and a fourth level signal V4 serving as a logic low level. When the vaporizer 10 is connected to the battery rod 20, the battery rod 20 sends the first level signal V1 serving as a logic high level and the second level signal V2 serving as a logic low level to the vaporizer 10 as the first communication signal, and after receiving the first communication signal, the vaporizer 10 sends the third level signal V3 serving as a logic high level and the fourth level signal V4 serving as a logic low level to the battery rod 20.

Specifically, the battery rod 20 further includes a first voltage unit 22 and a second voltage unit 23. The first voltage unit 22 is connected to the control unit 21 and the first connection end n1, to send the first level signal V1 to the vaporizer 10; and the second voltage unit 23 is connected to the control unit 21 and the first connection end n1, to send the second level signal V2 to the vaporizer 10.

Referring to FIG. 3, the first voltage unit 22 includes a voltage 1 and a switch 1, and the second voltage unit 23 includes a voltage 2 and a switch 2. Turn-on and turn-off of the switch 1 and the switch 2 are controlled by the control unit 21. Specifically, when the switch 1 is turned on, the battery rod 20 sends the first level signal V1 serving as a logic high level to the vaporizer 10 through the first connection end n1, to implement sending of data “1”; and when the switch 2 is turned on, the battery rod 20 sends the second level signal V2 serving as a logic low level to the vaporizer 10 through the first connection end n1, to implement sending of data “0”.

In an embodiment, when the signal source 12 works in the first state, a voltage on the first connection end n1 is maintained at the third level signal V3; and when the signal source 12 works in the second state, the voltage on the first connection end n1 is maintained at the fourth level signal V4. Specifically, after the vaporizer 10 receives the first communication signal, the processing unit CPU outputs the first control signal through the first control interface Sig-out to drive the signal source 12 to work in the first state. In this case, the signal source 12 is in a non-working state, the voltage on the two ends (namely, the first connection end n1/m1) of the heating element 13 is the third level signal V3 serving as a logic high level, thereby implementing sending of data “1” from the vaporizer 10 to the battery rod 20. The processing unit CPU outputs the first control signal through the first control interface Sig-out to drive the signal source 12 to work in the second state. In this case, the signal source 12 is in a working state, the signal source 12 is connected to the heating element 13 in parallel, the divider voltage between the signal source and the internal resistance of the switch 1 is reduced, and the value of the voltage on the two ends (namely, the first connection end n1/m1) of the heating element 13 is reduced to be the fourth level signal V4 serving as a logic low level, thereby implementing sending of data “0” from the vaporizer 10 to the battery rod 20.

Further, the battery rod 20 further includes a signal identification unit 24. The signal identification unit 24 is connected to a signal acquisition end P3 of the control unit 21 and the first connection end n1, and configured to acquire the second communication signal, identify the second communication signal, and feed back an identification result to the signal acquisition end P3, for the battery rod 20 to determine whether the vaporizer 10 matches the battery rod according to the identification result. Specifically, the signal identification unit 24 acquires a voltage signal on the first connection end n1 and identifies the voltage signal, to determine whether the acquired voltage signal is the third level signal V3 serving as a logic high level or the fourth level signal V4 serving as a logic low level, and further determine whether a received data signal is “1” or “0”, feeds back the identification result to the signal acquisition end P3, and further determines whether the current vaporizer 10 matches the battery rod 20 by using the control unit 21. As shown in FIG. 3, the second connection end n2 of the battery rod 20 is grounded.

In an embodiment, as shown in FIG. 4, the first level signal V1 is greater than or equal to the third level signal V3, the fourth level signal V4 is greater than or equal to the second level signal V2, and the third level signal V3 is greater than the second level signal V2. FIG. 4 is only an example in which the first level signal V1 is greater than the third level signal V3, the fourth level signal V4 is greater than the second level signal V2, and the third level signal V3 is greater than the second level signal V2. In another embodiment, a voltage difference between the first level signal V1 and the second level signal V2 is greater than a voltage difference between the third level signal V3 and the fourth level signal V4. Optionally, the second level signal V2 is less than the fourth level signal V4. In this case, a current required by the anti-counterfeiting chip ASIC is relatively small, and a demodulation data circuit of the anti-counterfeiting chip ASIC is simpler, so that costs of the anti-counterfeiting chip ASIC is lower, and a design is simpler.

In another embodiment, as shown in FIG. 5, the first level signal V1 is greater than or equal to the third level signal V3, the fourth level signal V4 is less than the second level signal V2, and the third level signal V3 is greater than or equal to the second level signal V2. FIG. 5 is only an example in which the first level signal V1 is equal to the third level signal V3, the fourth level signal V4 is less than the second level signal V2, and the third level signal V3 is greater than the second level signal V2. In another embodiment, a voltage difference between the first level signal V1 and the second level signal V2 is less than a voltage difference between the third level signal V3 and the fourth level signal V4. Optionally, the fourth level signal V4 is less than the second level signal V2. In this case, when the vaporizer 10 returns the second communication signal, a voltage difference between high and low level signals is great, so that a communication anti-interference capability can be enhanced, which helps simplify a processing circuit for receiving signals of the battery rod 20, for example, simplify the signal identification unit 24.

In another embodiment, as shown in FIG. 6, the second level signal V2 is greater than the third level signal V3.

Specifically, in this application, a level signal sent by the battery rod 20 to the vaporizer 10 and a level signal sent by the vaporizer 10 to the battery rod 20 are both greater than a power supply voltage VDD. That is, the first level signal V1, the second level signal V2, the third level signal V3, and the fourth level signal V4 are all greater than the power supply voltage VDD of the anti-counterfeiting chip ASIC. In this way, power can be supplied to the anti-counterfeiting chip ASIC, and therefore no power supply capacitor is disposed in the anti-counterfeiting chip ASIC. Specifically, a power supply interface VDD is further provided in the anti-counterfeiting chip ASIC, and when the power supply interface VDD is connected to the first connection end m1 and the battery rod 20 communicates with the vaporizer 10 through the first connection end m1, power can be supplied to the anti-counterfeiting chip ASIC through the first connection end m1 simultaneously.

Further, the vaporizer 10 further includes a direction switching circuit 14. The direction switching circuit 14 is connected to a second control interface Sig-in of the processing unit CPU, and the direction switching circuit 14 is connected to the heating element 13 in parallel and configured to implement forward or reverse insertion of the vaporizer 10 into the battery rod 20 under driving of a second control signal. The direction switching circuit 14 in this embodiment and a direction switching circuit in the related art have a same structure, and details are not described herein again.

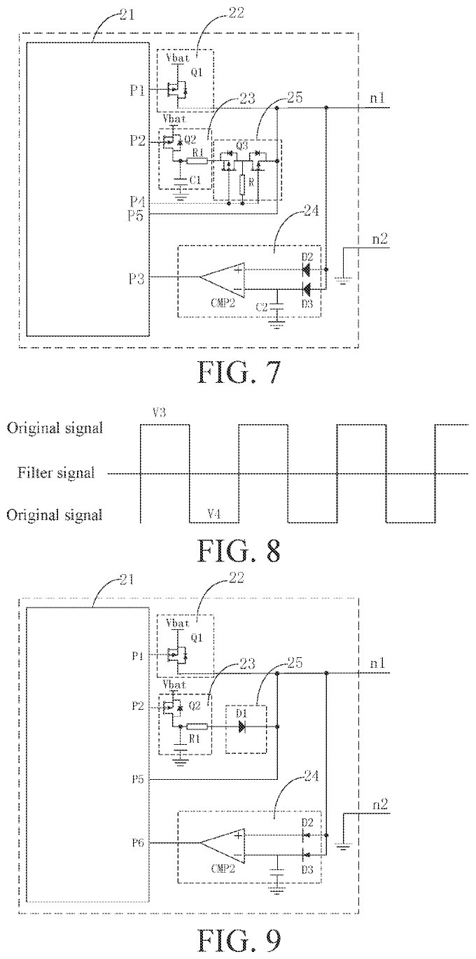

FIG. 7 is a schematic structural diagram of a first embodiment of the battery rod 20 shown in FIG. 2. The first voltage unit 22 includes a first switch Q1. The first switch Q1 includes a first path end, a second path end, and a control end, where the control end of the first switch Q1 is connected to a first driving end P1 to receive a first driving signal, the first path end of the first switch Q1 receives a battery voltage Vbat outputted by a battery, and the second path end of the first switch Q1 is connected to the first connection end n1.

The second voltage unit 23 includes a second switch Q2, a first resistor R1, and a first capacitor C1. The second switch Q2 includes a first path end, a second path end, and a control end, where the control end of the second switch Q2 is connected to a second driving end P2 to receive a second driving signal, the second driving signal is a PWM signal, and the first path end of the second switch Q2 receives the battery voltage Vbat. A first end of the first resistor R1 is connected to the second path end of the second switch Q2, and a second end of the first resistor R1 is connected to the first connection end n1. A first end of the first capacitor C1 is connected to the second path end of the second switch Q2, and a second end of the first capacitor C1 is grounded.

When the first driving signal outputted by the first driving end P1 of the control unit 21 controls the first switch Q1 to be turned on, the first voltage unit 22 sends the first level signal V1 to the vaporizer 10 by using the battery voltage Vbat. When the second driving signal outputted by the second driving end P2 of the control unit 21 controls the second switch Q2 to be turned on, the second voltage unit 23 sends the second level signal V2 to the vaporizer 10 by using the battery voltage Vbat. The second driving signal is a PWM signal, the second switch Q2 similarly forms a small switch power supply, and a constant voltage value can be outputted by controlling turn-on/turn-off of the second switch Q2 by using a PWM signal. Since the battery voltage Vbat may gradually decrease along with a working duration of the battery, a duty cycle and a frequency of the PWM signal may be controlled by a change value of the battery voltage Vbat, and a voltage value of the second level signal V2 sent by the second voltage unit 23 may be further controlled, thereby ensuring that a voltage difference between the first level signal V1 and the second level signal V2 is greater than a minimum voltage difference such as 0.7 V that can be identified by the anti-counterfeiting chip ASIC.

When the heating element 13 is heated, a PWM signal needs to be outputted to the heating element 13 through the first switch Q1. Since the first capacitor C1 has a relatively great capacitance value, during heating, a PWM waveform of the second path end (that is, the first connection end n1) of the first switch Q1 deforms. Further, in this embodiment, the battery rod 20 further includes a protection unit 25, and the protection unit 25 is connected to the second voltage unit 23 and the first voltage unit 22 and configured to prevent a heating signal of the first connection end n1 from being affected in a heating process.

Specifically, in this embodiment, the protection unit 25 includes a third switch Q3. The third switch Q3 is a dual-gate transistor, and includes a first path end, a second path end, and a control end, where the first path end of the third switch Q3 is connected to the second end of the first resistor R1, the control end of the third switch Q3 is connected to a P4 end of the control unit 21, and the second path end of the third switch Q3 is connected to the first connection end n1. Further, the control end of the third switch Q3 is further connected to a resistor R. When the battery rod 20 heats the vaporizer 10, the P4 end of the control unit 21 controls the third switch Q3 to be turned off, to cut off a path between the first switch Q1 and the first capacitor C1, and further prevent influence of the first capacitor C1 on the first switch Q1 during heating.

In this embodiment, the signal identification unit 24 includes a second comparator CMP2, a second diode D2, a third diode D3, and a second capacitor C2. The second comparator CMP2 includes a first input end, a second input end, and an output end, where the output end of the second comparator CMP2 is connected to a signal acquisition end P3 of the control unit 21. An anode of the second diode D2 is connected to the first connection end n1, and a cathode of the second diode D2 is connected to the first input end of the second comparator CMP2. An anode of the third diode D3 is connected to the first connection end n1, and a cathode of the third diode D3 is connected to the second input end of the second comparator CMP2. A first end of the second capacitor C2 is connected to the cathode of the third diode D3, and a second end of the second capacitor C2 is grounded.

Specifically, after the signal identification unit 24 acquires the second communication signal on the first connection end n1, the second communication signal is divided into two channels of signals through the second diode D2 and the third diode D3, where a signal passing through the second diode D2 is an original signal, and a signal passing through the third diode D3 is filtered through the second capacitor C2 to form a filter signal. The second comparator CMP2 compares the original signal with the filter signal, to identify whether a current obtained signal is the third level signal V3 or the fourth level signal V4. As shown in FIG. 8, if the original signal is greater than the filter signal, it indicates that the signal is the third level signal V3; and if the original signal is less than the filter signal, it indicates that the signal is the fourth level signal V4.

Further, the control unit 21 further includes a port P5 connected to the first connection end n1. The port P5 may be an analog-to-digital converter ADC carried in the control unit 21, which can detect a voltage value on the first connection end n1, and the voltage value on the first connection end n1 is equal to a voltage value of the heating element 13, so that a temperature of the heating element 13 can be obtained according to the voltage value on the first connection end n1. The battery rod 20 may further control the heating element 13 according to the temperature of the heating element 13. For example, if the temperature is excessively high, power can be properly reduced to reduce the temperature; and if the temperature is excessively low, power can be properly increased to increase the temperature.

FIG. 9 is a schematic structural diagram of a second embodiment of the battery rod 20 shown in FIG. 2. Compared with the first embodiment shown in FIG. 7, a difference lies in that: in this embodiment, the protection unit 25 includes a first diode D1, where an anode of the first diode D1 is connected to the second end of the first resistor R1, and a cathode of the first diode D1 is connected to the first connection end n1. A diode can be turned on in a direction from an anode to a cathode, so that influence of the first capacitor C1 on the first switch Q1 during heating can be prevented.

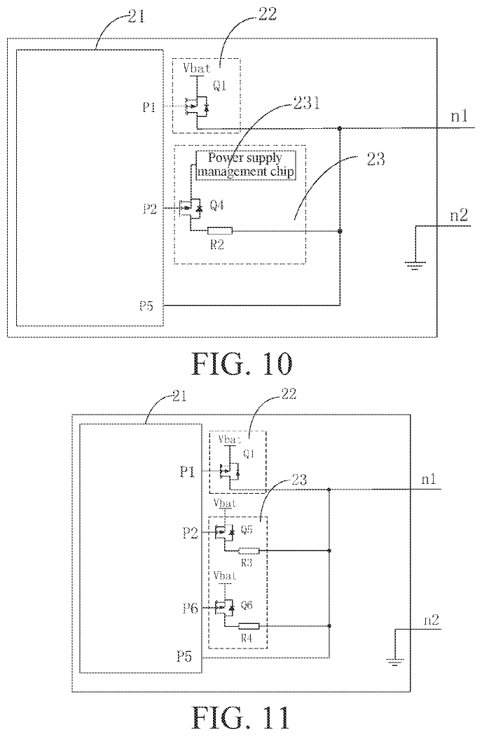

FIG. 10 is a schematic structural diagram of a third embodiment of the battery rod 20 shown in FIG. 2. Compared with the first embodiment shown in FIG. 7, a difference lies in that: in this embodiment, the second voltage unit 23 includes a fourth switch Q4 and a second resistor R2. The fourth switch Q4 includes a first path end, a second path end, and a control end, where the control end of the fourth switch Q4 is connected to the second driving end P2 to receive the second driving signal, and the first path end of the fourth switch Q4 is connected to a power supply management chip 231 to receive a voltage value outputted by the power supply management chip 231; and A first end of the second resistor R2 is connected to the second path end of the fourth switch Q4, and a second end of the second resistor R2 is connected to the first connection end n1. In this embodiment, the fourth switch Q4 is connected to the power supply management chip 231, for example, a switch power supply chip or a DC-DC chip, so that a constant voltage can be directly provided, and the voltage may not decrease as use time increases. In this embodiment, no capacitor needs to be disposed in the second voltage unit 23, and therefore the protection unit 25 does not need to be disposed. Further, the port P5 in this embodiment is the analog-to-digital converter ADC carried in the control unit 21 and serves as the signal identification unit 24. The port P5 is connected to the first connection end n1, so that the voltage value on the first connection end n1 can be detected, and the voltage value on the first connection end n1 is equal to the voltage value of the heating element 13. Therefore, the temperature of the heating element 13 can be obtained according to the voltage value on the first connection end n1. In addition, the port P5 can further detect the second communication signal on the first connection end n1. After the second communication signal is detected, the second communication signal is identified, and the third level signal V3 or the fourth level signal V4 is further obtained.

FIG. 11 is a schematic structural diagram of a fourth embodiment of the battery rod 20 shown in FIG. 2. Compared with the third embodiment shown in FIG. 10, a difference lies in that: in this embodiment, the second voltage unit 23 includes a fifth switch Q5, a third resistor R3, a sixth switch Q6, and a fourth resistor R4. The fifth switch Q5 includes a first path end, a second path end, and a control end, where the control end of the fifth switch Q5 is connected to the second driving end P2 to receive the second driving signal, the second driving signal is a PWM signal, and the first path end of the fifth switch Q5 receives the battery voltage Vbat outputted by the battery; a first end of the third resistor R3 is connected to the second path end of the fifth switch Q5, and a second end of the third resistor R3 is connected to the first connection end n1; the sixth switch Q6 includes a first path end, a second path end, and a control end, where the control end of the sixth switch Q6 is connected to a third driving end P6 to receive a third driving signal, and the first path end of the sixth switch Q6 receives the battery voltage Vbat outputted by the battery; and a first end of the fourth resistor R4 is connected to the second path end of the sixth switch Q6, and a second end of the fourth resistor R4 is connected to the first connection end n1.

In this embodiment, turn-on of the fifth switch Q5 or the sixth switch Q6 may be selected according to a voltage value of the battery voltage Vbat. Specifically, when the battery voltage Vbat provided by the fifth switch Q5 is greater than a predetermined value, the fifth switch Q5 is turned on, and the fifth switch Q5 outputs the second level signal V2 by using the battery voltage Vbat; and when the battery voltage Vbat provided by the fifth switch Q5 is less than the predetermined value, the sixth switch Q6 is turned on, so that the constant second level signal V2 decreases, thereby ensuring that a difference between the battery voltage Vbat and the second level signal V2 is maintained within a predetermined range.

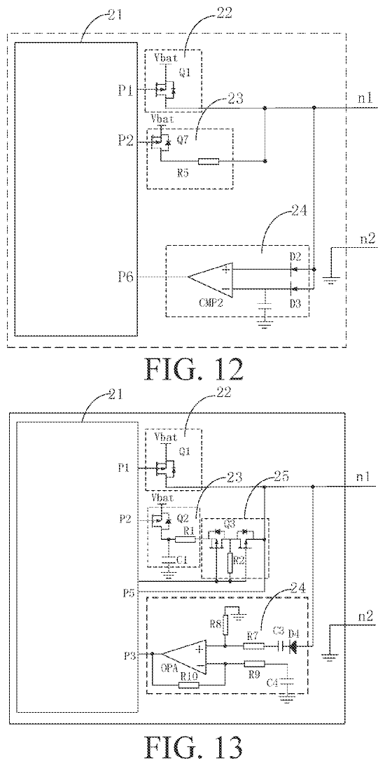

FIG. 12 is a schematic structural diagram of a fifth embodiment of the battery rod 20 shown in FIG. 2. Compared with the second embodiment shown in FIG. 9, a difference lies in that: in this embodiment, the second voltage unit 23 includes a seventh switch Q7 and a fifth resistor R5. The seventh switch Q7 includes a first path end, a second path end, and a control end, where the control end of the seventh switch Q7 is connected to the second driving end P2 to receive the second driving signal, the second driving signal is a level signal, and the first path end of the seventh switch Q7 receives the battery voltage Vbat of the battery; and a first end of the fifth resistor R5 is connected to the second path end of the seventh switch Q7, and a second end of the fifth resistor R5 is connected to the first connection end n1.

In this embodiment, the second driving signal is a level signal, when the first switch Q1 is turned on, the first level signal V1 is sent to the vaporizer 10; and when the seventh switch Q7 is turned on, the second level signal V2 is sent to the vaporizer 10.

FIG. 13 is a schematic structural diagram of a sixth embodiment of the battery rod 20 shown in FIG. 2. Compared with the first embodiment shown in FIG. 7, a difference lies in that: in this embodiment, the signal identification unit 24 includes an operational amplifier OPA, a seventh resistor R7, an eighth resistor R8, a ninth resistor R9, a tenth resistor R10, a third capacitor C3, a fourth capacitor C4, and a fourth diode D4. The operational amplifier OPA includes a first input end, a second input end, and an output end, where the output end of the operational amplifier OPA is connected to the signal acquisition end P3 of the control unit 21; a first end of the seventh resistor R7 is connected to the first input end of the operational amplifier OPA; a first end of the eighth resistor R8 is connected to the first input end of the operational amplifier OPA, and a second end of the eighth resistor R8 is grounded; a first end of the ninth resistor R9 is connected to the second input end of the operational amplifier OPA, and a second end of the ninth resistor R9 is grounded; a first end of the tenth resistor R10 is connected to the second input end of the operational amplifier OPA, and a second end of the tenth resistor R10 is connected to the output end of the operational amplifier OPA; a first end of the third capacitor C3 is connected to a second end of the seventh resistor R7; an anode of the fourth diode D4 is connected to the first connection end n1, and a cathode of the fourth diode D4 is connected to a second end of the third capacitor C3; and a first end of the fourth capacitor C4 is connected to the second end of the ninth resistor R9, and a second end of the fourth capacitor C4 is grounded.

In this embodiment, the second communication signal sent by the vaporizer 10 on the first connection end n1 is converted into an alternating current signal after isolation direct current filtering by the third capacitor C3 is performed on the second communication signal. The operational amplifier amplifies the alternating current signal to obtain high and low level signals. The control unit 21 identifies the third level signal V3 and the fourth level signal V4 according to the high and low level signals.

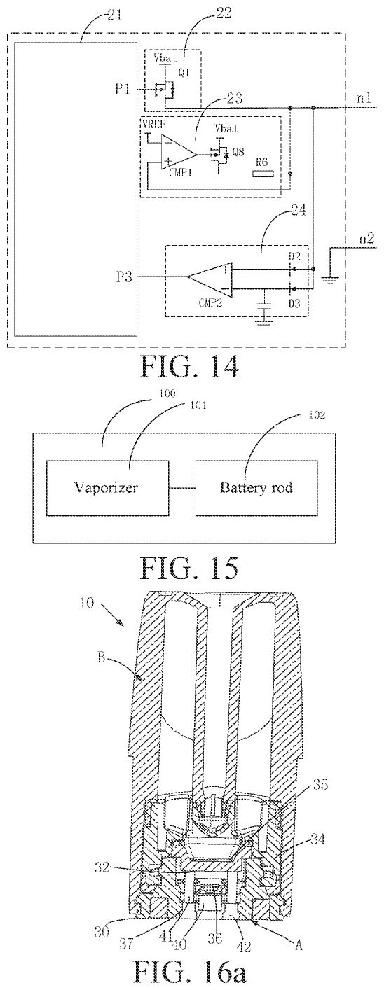

FIG. 14 is a schematic structural diagram of a seventh embodiment of the battery rod 20 shown in FIG. 2. Compared with the fifth embodiment shown in FIG. 12, a difference lies in that: the second voltage unit 23 includes a first comparator CMP1, an eighth switch Q8, and a sixth resistor R6. The first comparator CMP1 includes a first input end, a second input end, and an output end, where the first input end of the first comparator CMP1 receives a reference voltage VREF, and the second input end of the first comparator CMP1 is connected to the first connection end n1; the eighth switch Q8 includes a first path end, a second path end, and a control end, where the control end of the eighth switch Q8 is connected to the output end of the first comparator CMP1, and the first path end of the eighth switch Q8 receives the battery voltage Vbat of the battery; and a first end of the sixth resistor R6 is connected to the second path end of the eighth switch Q8, and a second end of the sixth resistor R6 is connected to the first connection end n1.

In this embodiment, the first comparator CMP1 obtains the first communication signal on the first connection end n1, and compares the first communication signal with the reference voltage VREF. If the first communication signal on the first connection end n1 is greater than the reference voltage VREF, the first comparator CMP1 controls the eighth switch Q8 to be turned off, to decrease the first communication signal to be close to the reference voltage VREF. If the first communication signal on the first connection end n1 is less than the reference voltage VREF, the first comparator CMP1 controls the eighth switch Q8 to be turned on, to increase the first communication signal to be close to the reference voltage VREF, thereby implementing sending of the first level signal V1 and the second level signal V2 from the battery rod 20 to the vaporizer 10.

FIG. 15 is a schematic structural diagram of an embodiment of an electronic vaporization device according to this application. The electronic vaporization device 100 includes a vaporizer 101 and a battery rod 102. The vaporizer 101 is the vaporizer 10 shown in FIG. 1, and the battery rod 102 is the battery rod 20 shown in any embodiment in FIG. 2 and FIG. 6 to FIG. 14. The battery rod 20 is configured to supply power to the vaporizer 10, to vaporize a to-be-vaporized substrate in the vaporizer 10. Specifically, when the battery rod 20 is connected to the vaporizer 10, the battery rod 20 sends a first communication signal to the vaporizer 10, and the vaporizer 10 feeds back a second communication signal to further determine whether the vaporizer 10 matches the battery rod 20.

In this application, an anti-counterfeiting circuit 11 is used to implement communication between the battery rod 20 and the vaporizer 10, and the anti-counterfeiting circuit 11 is integrated on an anti-counterfeiting chip ASIC, thereby replacing a solution of implementing communication by using a circuit board in the related art. The anti-counterfeiting chip ASIC can be manufacture in a form of a wafer, so that the anti-counterfeiting chip ASIC has a feature of a small volume and is easy to mount.

FIG. 16a is a schematic structural diagram of a first embodiment of the vaporizer 10 according to this application. The vaporizer 10 may be applied to fields such as electronic vaporization devices and medical vaporization, and has a feature of a specific structure, which facilitates an automatic mounting method. Therefore, a mounting process can be simplified, the assembly efficiency can be improved, labor costs during assembly can be reduced, and some human errors in an assembly process can be avoided.

In some embodiments, the vaporizer 10 may include a vaporization unit A and a liquid storage unit B sleeved on the vaporization unit A, where the liquid storage unit B is in communication with the vaporization unit A in a liquid guiding manner. The vaporization unit A may be configured to heat and vaporize a liquid medium stored in the liquid storage unit B, and the liquid storage unit B is configured to store the liquid medium and export vapor.

Specifically, in some embodiments, the vaporization unit A may include a vaporization bottom base 30, a vaporization assembly 35, and a vaporization top base 34. In some embodiments, the vaporization bottom base 30 may be in a shape of an ellipse and may be electrically connected to the battery rod 20, and the vaporization assembly 35 is mounted on the vaporization bottom base 30. The vaporization top base 34 is sleeved or clamped on the vaporization bottom base 30 from top to bottom and covers the vaporization assembly 35. The vaporization top base 34 may include an integrally formed sleeve, and the sleeve may be sleeved on the vaporization bottom base 30, to accommodate the vaporization assembly 35 and form a vaporization cavity 36. Structures of the vaporization bottom base 30, the vaporization assembly 35, and the vaporization top base 34 are not limited, and may be designed according to different types of the vaporizer 10.

Specifically, the vaporization assembly 35 further includes a heating element 13, and the vaporizer 10 further includes an anti-counterfeiting component 40. Specifically, the vaporization assembly 35 includes an electrode contact 32, the electrode contact 32 is positive and negative electrodes of the heating element 13, and the anti-counterfeiting component 40 includes an electrode connection portion 41. The electrode connection portion 41 of the anti-counterfeiting component 40 is electrically connected to the electrode contact 32, to connect the heating element 13 with the anti-counterfeiting component 40 in parallel. The anti-counterfeiting component 40 includes an anti-counterfeiting unit 413, and an anti-counterfeiting chip ASIC is encapsulated in the anti-counterfeiting unit 413. The anti-counterfeiting chip ASIC is the anti-counterfeiting chip ASIC in the vaporizer 10 shown in FIG. 1, and as shown in FIG. 1, the anti-counterfeiting chip ASIC may be a wafer, and an anti-counterfeiting circuit 11 is integrated on the wafer. Specifically, the anti-counterfeiting circuit 11 integrated on the anti-counterfeiting chip ASIC includes a processing unit CPU and a signal source 12 connected to the processing unit CPU, where the processing unit CPU controls the signal source 12 to work in a first state or a second state, to communicate with the battery rod 20, and further determine whether the battery rod 20 matches the vaporizer 10. Detailed principles are not described herein again.

As described above, the anti-counterfeiting chip ASIC needs to be connected to the heating element 13 in parallel to implement communication between the vaporizer 10 and the battery rod 20. In this embodiment, as shown in FIG. 16b, the heating element 13 is located on the vaporization assembly 35. Specifically, the anti-counterfeiting chip ASIC is electrically connected to the electrode connection portion 41, and is further electrically connected to the electrode contact 32 of the vaporization assembly 35. Therefore, the anti-counterfeiting chip ASIC can be connected to the heating element 13 in parallel, and the vaporizer 10 can communicate with the battery rod 20 through the anti-counterfeiting chip ASIC and further determine whether the battery rod 20 matches the vaporizer 10. Specifically, the vaporizer 10 further includes a conductive component 42, a first end of the conductive component 42 is electrically connected to the electrode contact 32 through the electrode connection portion 41, and a second end is exposed from the bottom portion of the vaporizer 10 to serve as an electrode (namely, the first connection end m1 and the second connection end m2) of the vaporizer 10. When the vaporizer 10 is connected to the battery rod 20, an electrode (namely, the first connection end n1 and the second connection end n2) of the battery rod 20 is correspondingly connected to the electrode (namely, the first connection end m1 and the second connection end m2) of the vaporizer 10, so that the anti-counterfeiting component 40 can communicate with the battery rod 20 and further determine whether the battery rod 20 matches the vaporizer 10. Specifically, the second end of the conductive component 42 exposed from the bottom portion of the vaporizer 10 is the first connection end m1 and the second connection end m2 of the vaporizer 10 shown in FIG. 1.

In a specific embodiment, the electrode contact 32 includes a first electrode contact 321 and a second electrode contact 322; the electrode connection portion 41 includes a first electrode connection portion 411 and a second electrode connection portion 412; and the conductive component 42 includes a first conductive component 421 and a second conductive component 422. A first end of the first electrode connection portion 411 abuts against the first electrode contact 321, and a second end thereof is connected to the anti-counterfeiting unit 413. A first end of the second electrode connection portion 412 abuts against the second electrode contact 322, and a second end thereof is connected to the anti-counterfeiting unit 413. A first end of the first conductive component 421 abuts against the second end of the first electrode connection portion 411, and a second end of the first conductive component 421 is inserted into a through hole 37 of the vaporization bottom base 30 of the vaporizer 10 and exposed, to serve as a first electrode (namely, the first connection end m1) of the vaporizer 10; and a first end of the second conductive component 422 abuts against the second end of the second electrode connection portion 412, and a second end of the second conductive component 422 is inserted into the through hole 37 of the vaporization bottom base 30 of the vaporizer 10 and exposed, to serve as a second electrode (namely, the second connection end m2) of the vaporizer 10.

As shown in FIG. 16b, in the anti-counterfeiting component 40, the anti-counterfeiting unit 413 is located between the first conductive component 421 and the second conductive component 422, and the second end of the first electrode connection portion 411 and the second end of the second electrode connection portion 412 are disposed on two opposite sides of the anti-counterfeiting unit 413 respectively. Specifically, in this embodiment, an orthographic projection of the anti-counterfeiting unit 413 on the vaporization bottom base 30 completely does not overlap with orthographic projections of the second end of the first electrode connection portion 411 and the second end of the second electrode connection portion 412 on the vaporization bottom base 30. In an embodiment, positive and negative pins are connected to the anti-counterfeiting chip ASIC in the anti-counterfeiting unit 413, and the second end of the first electrode connection portion 411 and the second end of the second electrode connection portion 412 are connected to the positive and negative pins respectively. According to the foregoing manner, the anti-counterfeiting component 40 is connected to the heating element 13 in parallel; and further, when the battery rod 20 is connected to the vaporizer 10, the battery rod 20 can send the first communication signal to the vaporizer 10, and the vaporizer 10 can feed back the second communication signal to the battery rod 20 to implement communication, thereby determining whether the battery rod 20 matches the vaporizer 10.

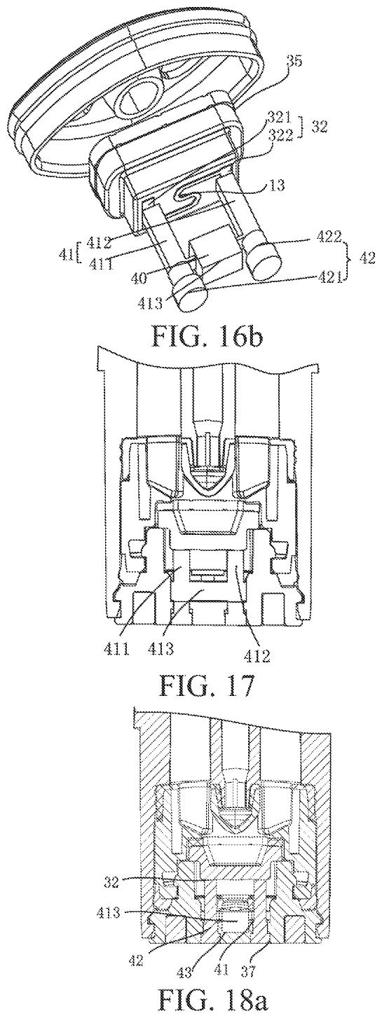

FIG. 17 is a schematic structural diagram of a second embodiment of the vaporizer 10 according to this application. Compared with the first embodiment shown in FIG. 16a and FIG. 16b, a difference lies in that: in this embodiment, the second end of the first electrode connection portion 411 and the second end of the second electrode connection portion 412 are both disposed on the surface of the anti-counterfeiting unit 413 facing the vaporization assembly 35, namely, the first electrode connection portion 411 and the second electrode connection portion 412 are located between the vaporization assembly 35 and the anti-counterfeiting unit 413. Specifically, an orthographic projection of the anti-counterfeiting unit 413 on the vaporization bottom base 30 partially overlaps with orthographic projections of the first electrode connection portion 411 and the second electrode connection portion 412 on the vaporization bottom base 30.

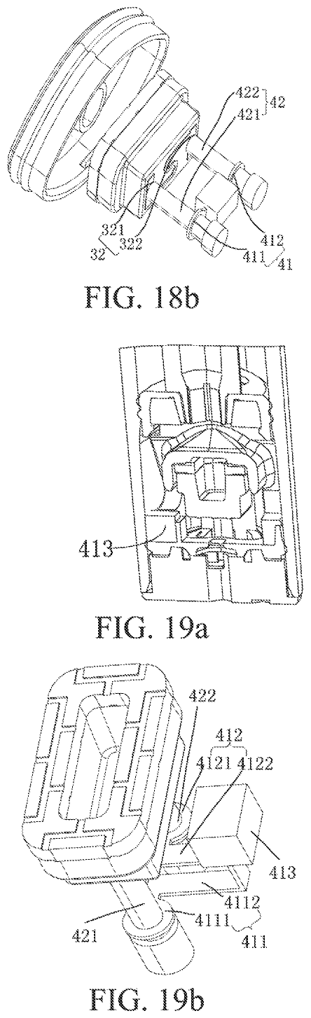

FIG. 18a and FIG. 18b are schematic structural diagrams of a third embodiment of the vaporizer 10 according to this application. In this embodiment, the first end of the conductive component 42 abuts against the electrode contact 32, and the second end is exposed from the bottom portion of the vaporizer 10 to serve as an electrode (namely, the first connection end m1 and the second connection end m2) of the vaporizer 10. The electrode connection portion 41 is connected to a part located between the first end and the second end of the conductive component 42, and the electrode connection portion 41 is electrically connected to the electrode contact 32 through the conductive component 42. When the vaporizer 10 is connected to the battery rod 20, an electrode of the battery rod 20 is correspondingly connected to the electrode of the vaporizer 10, so that the anti-counterfeiting component 40 can communicate with the battery rod 20 and further determine whether the battery rod 20 matches the vaporizer 10.

Specifically, the first end of the first conductive component 421 abuts against the first electrode contact 321, and the second end of the first conductive component is inserted into the through hole 37 of the vaporization bottom base 30 of the vaporizer 10 and exposed, to serve as the first electrode (namely, the first connection end m1) of the vaporizer 10. The first end of the second conductive component 422 abuts against the second electrode contact 322, and the second end of the second conductive component is inserted into the through hole 37 of the vaporization bottom base 30 of the vaporizer 10 and exposed, to serve as the second electrode (namely, the second connection end m2) of the vaporizer 10. The first electrode connection portion 411 is connected to a part between the first end and the second end of the first conductive component 421, and the second electrode connection portion 412 is connected to a part between the first end and the second end of the second conductive component 422.

According to the foregoing manner, the anti-counterfeiting component 40 is connected to the heating element 13 in parallel; and further, when the battery rod 20 is connected to the vaporizer 10, the battery rod 20 can send the first communication signal to the vaporizer 10, and the vaporizer 10 can feed back the second communication signal to the battery rod 20 to implement communication, thereby determining whether the battery rod 20 matches the vaporizer 10.

Specifically, in this embodiment, the first electrode connection portion 411 and the second electrode connection portion 412 are disposed on two opposite sides of the anti-counterfeiting unit 413 respectively, the first electrode connection portion 411 and the second electrode connection portion 412 are annular, and the first electrode connection portion 411 and the second electrode connection portion 412 are sleeved on the first conductive component 421 and the second conductive component 422 respectively, so that the anti-counterfeiting unit 413 is disposed between the first electrode connection portion 411 and the second electrode connection portion 412. In this embodiment, an orthographic projection of the anti-counterfeiting unit 413 on the vaporization bottom base 30 completely does not overlap with orthographic projections of the second end of the first electrode connection portion 411 and the second end of the second electrode connection portion 412 on the vaporization bottom base 30.

FIG. 19a and FIG. 19b are schematic structural diagrams of a fourth embodiment of the vaporizer 10 according to this application. Compared with the third embodiment shown in FIG. 18a and FIG. 18b, a difference lies in that: in this embodiment, the first electrode connection portion 411 includes a first sleeve portion 4111 and a first extending portion 4112, the second electrode connection portion 412 includes a second sleeve portion 4121 and a second extending portion 4122, and the first sleeve portion 4111 and the second sleeve portion 4121 are sleeved on the first conductive component 421 and the second conductive component 422 respectively. In this embodiment, the anti-counterfeiting unit 413 is disposed on a same side of a line in which the first sleeve portion 4111 and the second sleeve portion 4121 are located and is connected to the first sleeve portion 4111 and the second sleeve portion 4121 respectively through the first extending portion 4112 and the second extending portion 4122. Specifically, as shown in FIG. 18a, the anti-counterfeiting unit 413 is disposed at a side position of the vaporization bottom base 30.

In the first embodiment to the fourth embodiment described above, the conductive component is an electrode column, which may be made of any conductive material, may be in a shape of a column, and a cross section thereof is a circle, a rectangle, or a triangle.

In a specific embodiment, the anti-counterfeiting unit 413 may be disposed on the side of the vaporization bottom base 30 of the vaporizer 10 close to the vaporization assembly 35, and may be disposed at intervals with the vaporization bottom base 30 of the vaporizer 10. That is, the anti-counterfeiting unit 413 is not in contact with the vaporization bottom base 30 of the vaporizer 10. In another embodiment, the anti-counterfeiting unit 413 may be disposed on the surface of the side of the vaporization bottom base 30 of the vaporizer 10 close to the vaporization assembly 35. That is, the anti-counterfeiting unit 413 is in contact with the vaporization bottom base 30 of the vaporizer 10. In another embodiment, the anti-counterfeiting unit 413 may alternatively be disposed in a groove 43 or a through hole 43 of the vaporization bottom base 30 of the vaporizer 10. Specifically, this example is shown in FIG. 18a. In the embodiment shown in FIG. 18a, the vaporization bottom base 30 of the vaporizer 10 is provided with a groove 43, and the anti-counterfeiting unit 413 is disposed in the groove 43. The groove 43 may be a groove formed by concaving from the side of the vaporization bottom base 30 close to the vaporization assembly 35, or may be a groove formed by concaving from the side of the vaporization bottom base 30 away from the vaporization assembly 35. In another embodiment, the groove 43 may alternatively be a through hole 43, and the anti-counterfeiting unit 413 is disposed in the through hole 43. In an embodiment, if the groove 43 is a through hole 43, a protection member may be further disposed on the side of the anti-counterfeiting unit 413 in the through hole 43 away from the vaporization assembly 35, and the protection member blocks the anti-counterfeiting unit 413 in the vaporization bottom base 30 to prevent the anti-counterfeiting unit 413 from being exposed or worn out. Alternatively, in another embodiment, the protection member is not disposed, and a plastic packaging glue is disposed on the side of the anti-counterfeiting unit 413 in the through hole 43 away from the vaporization assembly 35. Alternatively, in another embodiment, no matter in the groove 43 or the through hole 43, a protection member may be further disposed on the side of the anti-counterfeiting unit 413 close to the vaporization assembly 35, the protection member and the anti-counterfeiting unit 413 are stacked, and the protection member can fix the anti-counterfeiting unit 413 in the groove 43 or the through hole 43, to prevent movement of the anti-counterfeiting unit 413.

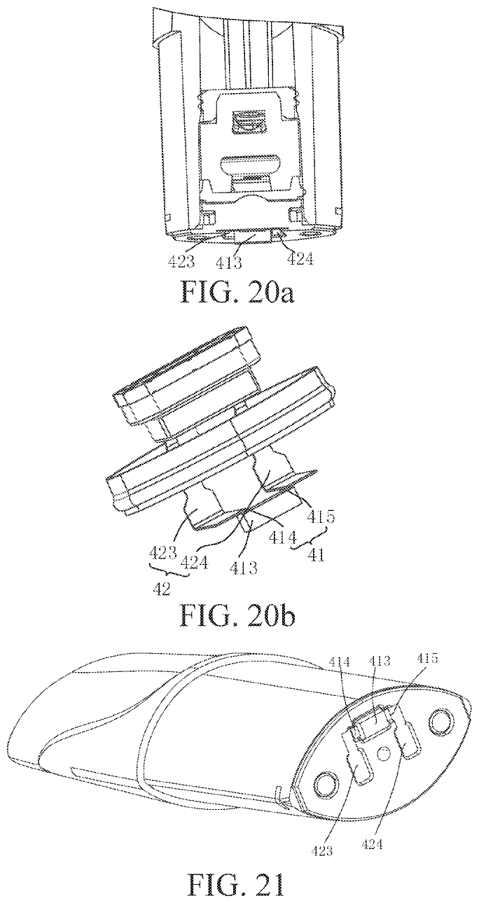

FIG. 20a and FIG. 20b are schematic structural diagrams of a fifth embodiment of the vaporizer 10 according to this application. In this embodiment, the conductive component 42 includes a first elastic sheet 423 and a second elastic sheet 424. The electrode connection portion 41 includes a first pin 414 and a second pin 415, where the first pin 414 and the second pin 415 are located on a surface of the anti-counterfeiting unit 413.

The first elastic sheet 423 and the second elastic sheet 424 run through the vaporization bottom base 30 of the vaporizer 10 and are bent, a first end of the first elastic sheet 423 abuts against the first electrode contact 321, a second end of the first elastic sheet is disposed on the surface of the vaporization bottom base 30 of the vaporizer 10 away from the vaporization assembly 35, a first end of the second elastic sheet 424 abuts against the second electrode contact 322, and a second end of the second elastic sheet is disposed on the surface of the vaporization bottom base 30 of the vaporizer 10 away from the vaporization assembly 35. The anti-counterfeiting unit 413 is electrically connected to the first elastic sheet 423 and the second elastic sheet 424 respectively through the first pin 414 and the second pin 415.

As shown in FIG. 20a, in this embodiment, the first elastic sheet 423 is exposed at the bottom portion of the vaporization bottom base 30 to serve as the first electrode (namely, the first connection end m1) of the vaporizer 10, and the second elastic sheet 412 is exposed at the bottom portion of the vaporization bottom base 30 to serve as the second electrode (namely, the second connection end m2) of the vaporizer 10. In this embodiment, the anti-counterfeiting unit 413 is disposed on the surface of the side of the vaporization bottom base 30 of the vaporizer 10 away from the vaporization assembly 35, and is exposed at the bottom portion of the vaporization bottom base 30 of the vaporizer 10. The first pin 414 is at least partially disposed between the anti-counterfeiting unit 413 and the first elastic sheet 423, and the second pin 415 is at least partially disposed between the anti-counterfeiting unit 413 and the second elastic sheet 412. Specifically, orthographic projections of the first pin 414, the first elastic sheet 423, and the anti-counterfeiting unit 413 on the vaporization bottom base 30 partially overlap with each other, and orthographic projections of the second pin 415, the second elastic sheet 424, and the anti-counterfeiting unit 413 on the vaporization bottom base 30 completely overlap with each other. The first pin 414 is connected to the first electrode contact 321 of the vaporization assembly 35 through the first elastic sheet 423, and the second pin 415 is connected to the second electrode contact 322 of the vaporization assembly 35 through the second elastic sheet 424, so that the anti-counterfeiting unit 413 is connected to the heating element 13 in the vaporization assembly 35 in parallel. When the vaporizer 10 is connected to the battery rod 20, communication between the vaporizer 10 and the battery rod 20 is implemented, and whether the vaporizer 10 matches the battery rod 20 is further determined.

FIG. 21 is a schematic structural diagram of a sixth embodiment of the vaporizer 10 according to this application. Compared with the fifth embodiment shown in FIG. 20a and FIG. 20b, a difference lies in that: in this embodiment, the anti-counterfeiting unit 413 is disposed on the side of the vaporization bottom base 30 of the vaporizer 10 away from the vaporization assembly 35, the first pin 414 is at least partially disposed between the vaporization bottom base 30 of the vaporizer 10 and the first elastic sheet 423, and the second pin 415 is at least partially disposed between the vaporization bottom base 30 of the vaporizer 10 and the second elastic sheet 424. Specifically, in this embodiment, orthographic projections of the first pin 414, the first elastic sheet 423, and the anti-counterfeiting unit 413 on the vaporization bottom base 30 completely do not overlap with each other, and orthographic projections of the second pin 415, the second elastic sheet 424, and the anti-counterfeiting unit 413 on the vaporization bottom base 30 completely do not overlap with each other.

In another embodiment, it may be alternatively set that the orthographic projections of the first pin 414 and the first elastic sheet 423 on the vaporization bottom base 30 partially overlap with each other, and the orthographic projections of the second pin 415 and the second elastic sheet 424 on the vaporization bottom base 30 at least partially overlap with each other. Details are not limited, provided that the first pin 414 and the second pin 415 of the anti-counterfeiting unit 413 can be connected to the first elastic sheet 423 and the second elastic sheet 424.

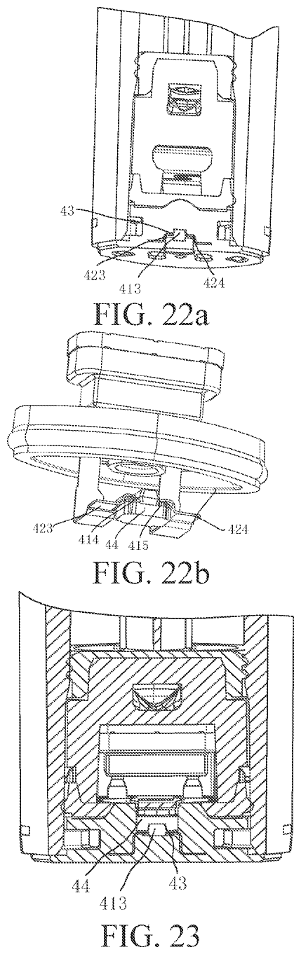

FIG. 22 is a schematic structural diagram of a seventh embodiment of the vaporizer 10 according to this application. Different from the fifth embodiment shown in FIG. 20a and FIG. 20b, a difference lies in that: in this embodiment, the side of the vaporization bottom base 30 of the vaporizer 10 away from the vaporization assembly 35 is provided with a groove 43, the anti-counterfeiting unit 413 is disposed in the groove 43, and the first elastic sheet 423 and the second elastic sheet 424 further extend into the groove 43 and are electrically connected to the first pin 414 and the second pin 415 respectively.

In this embodiment, the side of the vaporization bottom base 30 of the vaporizer 10 away from the vaporization assembly 35 is provided with a groove 43, and the anti-counterfeiting unit 413 is disposed in the groove 43. To protect the groove 43, a protection member 44 is further disposed in the groove 43, and the protection member 44 covers the anti-counterfeiting unit 413, to prevent the anti-counterfeiting unit 413 from being exposed at the bottom portion of the vaporization bottom base 30. Further, the protection member 44 may not be disposed, and to protect the anti-counterfeiting unit 413, sealing may be performed at a position corresponding to the anti-counterfeiting unit 413 of the bottom portion of the vaporization bottom base 30.

FIG. 23 is a schematic structural diagram of an eighth embodiment of the vaporizer 10 according to this application. Different from the seventh embodiment shown in FIG. 22a and FIG. 22b, a difference lies in that: in this embodiment, the anti-counterfeiting unit 413 is disposed in a groove 43 in the side of the vaporization bottom base 30 of the vaporizer 10 close to the vaporization assembly 35, and the first elastic sheet 423 and the second elastic sheet 424 further extend into the groove 43 and are electrically connected to the first pin 414 and the second pin 415 respectively.

In this embodiment, the protection member 44 is disposed on the side of the vaporization bottom base 30 of the vaporizer 10 close to the vaporization assembly 35 and covers the anti-counterfeiting unit 413. A position of the protection member 44 corresponding to the anti-counterfeiting unit 413 is provided with a groove 43 for accommodating the anti-counterfeiting unit 413, so that the anti-counterfeiting unit 413 can be fixed in the groove 43 of the vaporization bottom base 30.

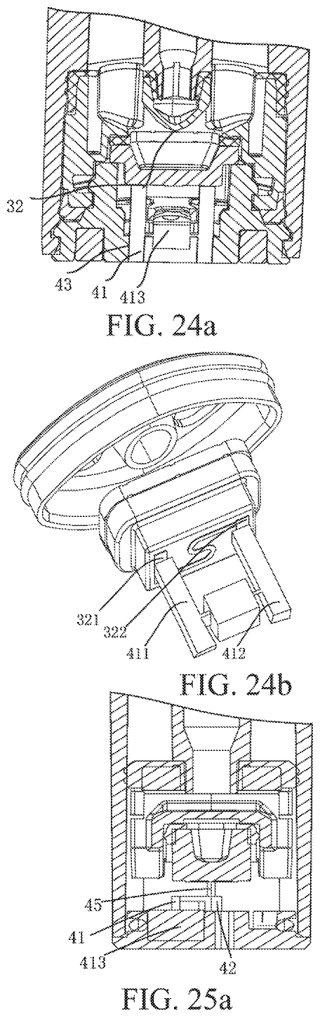

FIG. 24a and FIG. 24b are schematic structural diagrams of a ninth embodiment of the vaporizer 10 according to this application. In this embodiment, the anti-counterfeiting unit 413 is directly connected to the electrode contact 32 of the vaporization assembly 35 through the electrode connection portion 41. Specifically, one end of the electrode connection portion 41 is exposed from the bottom portion of the vaporizer 10 to serve as an electrode (namely, the first connection end m1 and the second connection end m2) of the vaporizer 10. When the vaporizer 10 is connected to the battery rod 20, an electrode of the battery rod 20 is correspondingly connected to the electrode of the vaporizer 10, so that the anti-counterfeiting component can communicate with the battery rod 20 and further determine whether the battery rod 20 matches the vaporizer 10.

Specifically, the electrode contact 32 includes a first electrode contact 321 and a second electrode contact 322. The electrode connection portion 41 includes a first electrode connection portion 411 and a second electrode connection portion 412. A first end of the first electrode connection portion 411 abuts against the first electrode contact 321, and a second end of the first electrode connection portion is inserted into the through hole 43 of the vaporization bottom base 30 of the vaporizer 10 and exposed, to serve as the first electrode (namely, the first connection end m1) of the vaporizer 10; and a first end of the second electrode connection portion 412 abuts against the second electrode contact 322, and a second end of the second electrode connection portion is inserted into the through hole 43 of the vaporization bottom base 30 of the vaporizer 10 and exposed, to serve as the second electrode (namely, the second connection end m2) of the vaporizer 10.

In this embodiment, a part between the first end and the second end of the first electrode connection portion 411 is electrically connected to the anti-counterfeiting unit 413; and a part between the first end and the second end of the second electrode connection portion 412 is electrically connected to the anti-counterfeiting unit 413.

In the foregoing embodiment, the anti-counterfeiting unit 413 may include a wafer and a package wrapping the wafer. Specifically, a conductive line is disposed on the wafer, the package encapsulates the wafer to form the anti-counterfeiting unit 413, and the package may further encapsulate the conductive line on the wafer, to form positive and negative pins electrically connected to the electrode connection portion 41. Further, the package may further encapsulate the electrode connection portion 41, so that the electrode connection portion 41 and the anti-counterfeiting unit 413, namely, the anti-counterfeiting component 40 form an independent element. Certainly, it may be understood that, the electrode connection portion 41 may alternatively serve as an independent element and exist independent of the anti-counterfeiting unit 413. That is, the anti-counterfeiting component 40 includes two parts: the separated anti-counterfeiting unit 413 and the electrode connection portion 41. In another embodiment, the anti-counterfeiting unit 413 may alternatively directly be a wafer, and the wafer is bound to the conductive component 42 through a conductive line such as a golden line or a copper line by using a binding machine, to be further connected to an electrode contact of the vaporization assembly.

In the foregoing embodiment, the conductive component, the electrode connection portion, and the electrode contact may be connected to each other through a riveting, crimping, welding, or bonding process.

In the vaporizer 10 provided in this application, the anti-counterfeiting component 40 may be located at any position in a cavity formed by the vaporization bottom base 30 and the vaporization assembly, or may be located in the through hole or the groove of the vaporization bottom base 30. In this application, the anti-counterfeiting component 40 is used to replace the circuit board that can implement communication in the related art. On one hand, the structure of the anti-counterfeiting component 40 is simple, so that a small volume can be implemented. On the other hand, costs can be reduced.

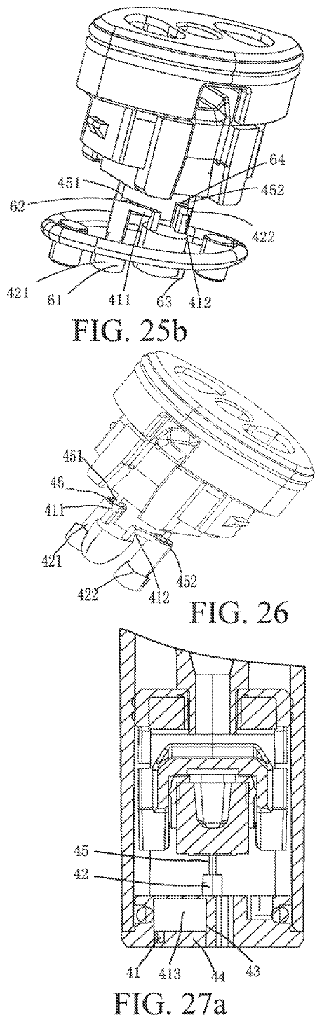

FIG. 25a and FIG. 25b are schematic structural diagrams of a tenth embodiment of the vaporizer 10 according to this application. Compared with the first embodiment shown in FIG. 16a and FIG. 16b, a difference lies in that: in this embodiment, the vaporization assembly 35 includes an electrode lead 45, and the anti-counterfeiting component 40 includes an electrode connection portion 41. The electrode connection portion 41 is connected to the electrode lead 45, to connect the vaporization assembly with the anti-counterfeiting component in parallel. Therefore, when the vaporizer 10 is connected to the battery rod 20, the anti-counterfeiting component 40 can communicate with the battery rod 20 and further determine whether the battery rod 20 matches the vaporizer 10.

Specifically, in this embodiment, the vaporizer 10 further includes a conductive component 42. The electrode connection portion 41 and the electrode lead 45 are connected through the conductive component 42, and one end of the conductive component 42 is exposed from the bottom portion of the vaporizer 10 to serve as an electrode (namely, the first connection end m1 and the second connection end m2) of the vaporizer 10. When the vaporizer 10 is connected to the battery rod 20, an electrode of the battery rod 20 is correspondingly connected to the electrode of the vaporizer 10, so that the anti-counterfeiting component can communicate with the battery rod 20 and further determine whether the battery rod 20 matches the vaporizer 10.

In an embodiment, the electrode connection portion 41 and the electrode lead 45 are disposed on the conductive component 42, to connect the anti-counterfeiting component 40 with the heating element 13 in the vaporization assembly 35 in parallel.

Specifically, the conductive component 42 includes a first conductive component 421 and a second conductive component 422. The electrode lead 45 includes a first electrode lead 451 and a second electrode lead 452. The electrode connection portion 41 includes a first electrode connection portion 411 and a second electrode connection portion 412.

The first conductive component 421 and the second conductive component 422 are electrode columns. The first electrode connection portion 411 and the first electrode lead 451 are connected through the first conductive component 421. Specifically, the first electrode connection portion 411 and the first electrode lead 451 may be welded, crimped, or riveted on the first conductive component 421. One end of the first conductive component 421 is inserted into a through hole of the vaporization bottom base 30 of the vaporizer 10 and exposed, to serve as the first electrode (namely, the first connection end m1) of the vaporizer 10. The second electrode connection portion 412 and the second electrode lead 452 are connected through the second conductive component 422. Specifically, the second electrode connection portion 412 and the second electrode lead 452 may be welded, crimped, or riveted on the second conductive component 422. One end of the second conductive component 422 is inserted into the through hole of the vaporization bottom base 30 of the vaporizer 10 and exposed, to serve as the second electrode (namely, the second connection end m2) of the vaporizer 10.

When the vaporizer 10 is connected to the battery rod 20, an electrode of the battery rod 20 is correspondingly connected to the electrode of the vaporizer 10, so that the anti-counterfeiting component can communicate with the battery rod 20 and further determine whether the battery rod 20 matches the vaporizer 10.

Specifically, the first conductive component 421 includes a first columnar body 61 and a second columnar body 62 protruding from the surface of the first columnar body 61, and the second conductive component 422 includes a third columnar body 63 and a fourth columnar body 64 protruding from the surface of the third columnar body 63. The first columnar body 61 and the third columnar body 63 are embedded in the through hole of the vaporization bottom base 30 of the vaporizer 10 and exposed; the first electrode connection portion 451 is inserted from the side surface of the first columnar body 61, extends out of the top surface, and is attached to the surface of the second columnar body 62; and the second electrode connection portion 452 is inserted from the side surface of the third columnar body 63, extends out of the top surface, and is attached to the surface of the fourth columnar body 64.

In this embodiment, the anti-counterfeiting unit 413 may be disposed on the side of the vaporization bottom base 30 of the vaporizer 10 close to the vaporization assembly 35, and may be disposed at intervals with the vaporization bottom base 30 of the vaporizer 10. Alternatively, the anti-counterfeiting unit 413 is disposed on the surface of the side of the vaporization bottom base 30 of the vaporizer 10 close to or away from the vaporization assembly 35. Alternatively, the anti-counterfeiting unit 413 is disposed in the groove or the through hole of the vaporization bottom base 35 of the vaporizer 10, which is not specifically limited.

FIG. 26 is a schematic structural diagram of an eleventh embodiment of the vaporizer 10 according to this application. Compared with the tenth embodiment shown in FIG. 25a and FIG. 25b, a difference lies in that: in this embodiment, the first conductive component 421 and the second conductive component 422 are electrode columns, and one end of each of the two conductive components away from the vaporization bottom base 30 is provided with a blind hole 46. The first electrode connection portion 411 and the first electrode lead 451 are inserted into the blind hole 46 of the first conductive component 421 to be connected to the first conductive component 421; and the second electrode connection portion 412 and the second electrode lead 452 are inserted into the blind hole 46 of the second conductive component 422 to be connected to the second conductive component 421.

In the ninth embodiment and the tenth embodiment, the electrode connection portion 41 is led out from the side of the anti-counterfeiting unit 413 close to the vaporization assembly 35. That is, the first electrode connection portion 411 and the second electrode connection portion 412 are led out from the surface of the anti-counterfeiting unit 413 close to the vaporization assembly 35.

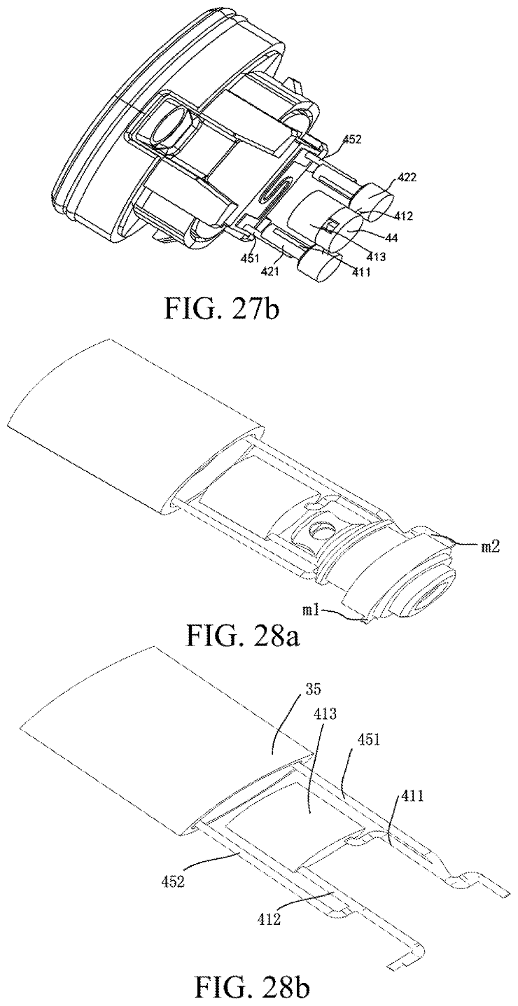

FIG. 27a and FIG. 27b are schematic structural diagrams of a twelfth embodiment of the vaporizer 10 according to this application. Compared with the eleventh embodiment shown in FIG. 26, a difference lies in that: in this embodiment, the electrode connection portion 41 is led out from the surface of the anti-counterfeiting unit 413 away from the vaporization assembly 35. That is, the first electrode connection portion 411 and the second electrode connection portion 412 are led out from the surface of the anti-counterfeiting unit 413 away from the vaporization assembly 35.

Further, this embodiment further includes a protection member 44, where the protection member 44 is stacked with the anti-counterfeiting unit 413 and is located on the side of the anti-counterfeiting unit 413 away from the vaporization assembly 35. In this embodiment, an opening of the groove 43 of the vaporization bottom base 30 is located at the surface of the vaporization bottom base 30 away from the vaporization assembly 35. The protection member 44 and the anti-counterfeiting unit 413 are placed in the groove 43, and the first electrode connection portion 411 and the second electrode connection portion 412 extend into the protection member 44 and further extend to positions of the first conductive component 421 and the second conductive component 422. Specifically, in this embodiment, the first electrode lead 451 and the first electrode connection portion 411 are connected to the first conductive component 421 in a welding/crimping/riveting manner, and the second electrode connection portion 412 and the second electrode lead 452 are connected to the second conductive component 422 in a welding/crimping/riveting manner, to connect the anti-counterfeiting component 413 with the heating element 13 in the vaporization assembly 35 in parallel.

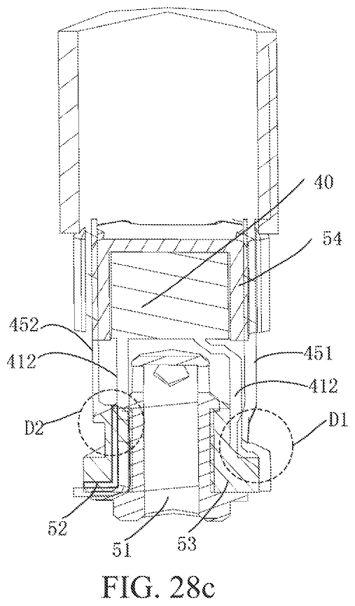

FIG. 28a, FIG. 28b, and FIG. 28c are schematic structural diagrams of a thirteenth embodiment of the vaporizer 10 according to this application. In this embodiment, the electrode lead 45 includes a first electrode lead 451 and a second electrode lead 452. The electrode connection portion 41 includes a first electrode connection portion 411 and a second electrode connection portion 412. The first electrode connection portion 411 is connected to the first electrode lead 451, and extends to the bottom portion of the vaporizer 10 to serve as the first electrode (namely, the first connection end m1) of the vaporizer 10; and the second electrode connection portion 412 is connected to the second electrode lead 452, and extends to the bottom portion of the vaporizer 10 to serve as the second electrode (namely, the second connection end m2) of the vaporizer 10. When the vaporizer 10 is connected to the battery rod 20, a positive electrode and a negative electrode of the battery rod 20 are correspondingly connected to the first electrode and the second electrode of the vaporizer 10, so that the anti-counterfeiting component 40 can communicate with the battery rod 20 and further determine whether the battery rod 20 matches the vaporizer 10.

As shown in FIG. 28c, the vaporizer 10 further includes a metal ejector pin 51, an insulating member 52, and a metal bottom base 53. The insulating member 52 is sleeved on the outer surface of the metal ejector pin 51; and the metal bottom base 53 is sleeved on the outer surface of the insulating member 52. Each of the first electrode connection portion 411 and/or the first electrode lead 451 extends to a position between the insulating member 52 and the metal bottom base 53 and is exposed at the bottom portion of the metal bottom base 53, and is connected to the metal bottom base 53 to serve as the second electrode (namely, the second connection end m2). Each of the second electrode connection portion 412 and/or the second electrode lead 452 extends to a position between the insulating member 52 and the metal ejector pin 51 and is exposed at the bottom portion of the metal bottom base 53, and is connected to the metal ejector pin 51 to serve as the first electrode (namely, the first connection end m1).

In this embodiment, the first electrode connection portion 411 and the first electrode lead 451 are connected at D1, and the second electrode connection portion 412 and the second electrode lead 452 are connected at D2.

As shown in FIG. 28b, the vaporization assembly 35 is located on the side of the metal bottom base 53 away from the first electrode (the first connection end m1) and the second electrode (the second connection end m2); and the anti-counterfeiting component 413 is located between the vaporization assembly 35 and the metal bottom base 53.

Further, as shown in FIG. 28c, the vaporizer 10 further includes a positioning member 54. The positioning member 54 is sleeved on the outer side of the anti-counterfeiting component 413 and abuts against the vaporization assembly 35, to fix the anti-counterfeiting component 40 between the vaporization assembly 35 and the metal bottom base 53.

In the vaporizer 10 provided in this application, the anti-counterfeiting component 40 may be located at any position in a cavity formed by the vaporization bottom base 30 and the vaporization assembly, or may be located in the through hole or the groove of the vaporization bottom base 30. In this application, the anti-counterfeiting component is used to replace the circuit board that can implement communication in the related art. On one hand, the structure of the anti-counterfeiting chip is simple, so that a small volume can be implemented. On the other hand, costs can be reduced.

The foregoing descriptions are merely implementations of this application, and the patent scope of this application is not limited thereto. All equivalent structure or process changes made according to the content of this specification and the accompanying drawings in this application or by directly or indirectly applying this application in other related technical fields shall fall within the protection scope of this application.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A vaporizer, comprising:
a first connection end and a second connection end, configured to be connected to a battery rod upon insertion of the vaporizer into the battery rod; and
an anti-counterfeiting circuit connected to the first connection end and the second connection end, the anti-counterfeiting circuit being configured to receive a first communication signal from the battery rod and to send a second communication signal to the battery rod through the first connection end to implement communication between the battery rod and the vaporizer,
wherein the first communication signal comprises a first level signal serving as a logic high level and a second level signal serving as a logic low level,
wherein the second communication signal comprises a third level signal serving as a logic high level and a fourth level signal serving as a logic low level, and
wherein the second level signal and the fourth level signal are greater than a power supply voltage of the anti-counterfeiting circuit.

2. The vaporizer of claim 1, wherein the first level signal is greater than or equal to the third level signal, the fourth level signal is greater than or equal to the second level signal, and the third level signal is greater than the second level signal.

3. The vaporizer of claim 1, wherein the first level signal is greater than or equal to the third level signal, the fourth level signal is less than or equal to the second level signal, and the third level signal is greater than or equal to the second level signal.

4. The vaporizer of claim 1, wherein the second level signal is greater than the third level signal.

5. The vaporizer of claim 1, wherein the anti-counterfeiting circuit comprises a signal source,
wherein the signal source is connected to the first connection end and the second connection end, and
wherein the signal source is configured to work in a first state or a second state to send the second communication signal to the battery rod.

6. The vaporizer of claim 5, wherein the anti-counterfeiting circuit comprises a processing unit comprising a first control interface configured to output a first control signal, and
wherein the signal source is connected to the first control interface and is configured to work in the first state or the second state under driving of the first control signal.

7. The vaporizer of claim 6, further comprising:
a heating element connected to the signal source in parallel, and connected in parallel between the first connection end and the second connection end,
wherein, when the signal source works in the first state, a voltage on the first connection end is maintained at the third level signal, and
wherein, when the signal source works in the second state, the voltage on the first connection end is maintained at the fourth level signal.

8. The vaporizer of claim 7, wherein the processing unit comprises a second control interface configured to output a second control signal, and
wherein the vaporizer further comprises:
a direction switching circuit connected to the second control interface and connected to the heating element in parallel, the direction switching circuit being configured to implement forward or reverse insertion of the vaporizer into the battery rod under driving of the second control signal.

9. The vaporizer of claim 1, wherein the anti-counterfeiting circuit is integrated and then encapsulated into an independent element.

10. A battery rod, comprising:
a first connection end and a second connection end, configured to be connected to a vaporizer inserted into the battery rod; and
a control unit connected to the first connection end and configured to send a first communication signal to the vaporizer inserted into the battery rod and receive a second communication signal from the vaporizer through the first connection end so as to implement communication between the battery rod and the vaporizer,
wherein the first communication signal comprises a first level signal serving as a logic high level and a second level signal serving as a logic low level,
wherein the second communication signal comprises a third level signal serving as a logic high level and a fourth level signal serving as a logic low level, and
wherein the second level signal and the fourth level signal are greater than a power supply voltage of an anti-counterfeiting circuit.

11. The battery rod of claim 10, wherein the first level signal is greater than or equal to the third level signal, the fourth level signal is greater than or equal to the second level signal, and the third level signal is greater than the second level signal.

12. The battery rod of claim 10, wherein the first level signal is greater than or equal to the third level signal, the fourth level signal is less than or equal to the second level signal, and the third level signal is greater than or equal to the second level signal.

13. The battery rod of claim 10, wherein the second level signal is greater than the third level signal.

14. The battery rod of claim 10, further comprising:
a first voltage unit connected to the control unit and the first connection end and configured to send the first level signal to the vaporizer; and
a second voltage unit connected to the control unit and the first connection end and configured to send the second level signal to the vaporizer.

15. The battery rod of claim 14, wherein the first voltage unit comprises:
a first switch comprising a first path end, a second path end, and a control end,
wherein the control end of the first switch is connected to a first driving end of the control unit to receive a first driving signal,
wherein the first path end of the first switch is configured to receive a battery voltage, and
wherein the second path end of the first switch is connected to the first connection end.

16. The battery rod of claim 15, wherein the second voltage unit comprises:
a second switch comprising a first path end, a second path end, and a control end,
wherein the control end of the second switch is connected to a second driving end of the control unit to receive a second driving signal, the second driving signal comprises a PWM signal, and the first path end of the second switch receives the battery voltage;
a first resistor, a first end of the first resistor being connected to the second path end of the second switch, and a second end of the first resistor being connected to the first connection end; and
a first capacitor, a first end of the first capacitor being connected to the second path end of the second switch, and a second end of the first capacitor being grounded.

17. The battery rod of claim 16, further comprising:
a protection unit connected to the second voltage unit and the first voltage unit and configured to prevent a heating signal of the first connection end from being affected in a heating process.

18. The battery rod of claim 17, wherein the protection unit comprises:
a third switch comprising a first path end, a second path end, and a control end, the first path end of the third switch being connected to the second end of the first resistor, the control end of the third switch being connected to the control unit, and the second path end of the third switch being connected to the first connection end; or
a first diode, an anode of the first diode being connected to the second end of the first resistor, and a cathode of the first diode being connected to the first connection end.

19. The battery rod of claim 15, wherein the second voltage unit comprises:
a fourth switch comprising a first path end, a second path end, and a control end, the control end of the fourth switch being connected to a second driving end of the control unit to receive a second driving signal, and the first path end of the fourth switch being connected to a power supply management chip to receive a voltage; and
a second resistor, a first end of the second resistor being connected to the second path end of the fourth switch, and a second end of the second resistor being connected to the first connection end.

20. The battery rod of claim 15, wherein the second voltage unit comprises:
a fifth switch comprising a first path end, a second path end, and a control end, the control end of the fifth switch being connected to a second driving end of the control unit to receive a second driving signal, the second driving signal comprising a PWM signal, and the first path end of the fifth switch being configured to receive the battery voltage;
a third resistor, a first end of the third resistor being connected to the second path end of the fifth switch, and a second end of the third resistor being connected to the first connection end;
a sixth switch comprising a first path end, a second path end, and a control end, the control end of the sixth switch being connected to a third driving end of the control unit to receive a third driving signal, and the first path end of the sixth switch being configured to receive the battery voltage; and
a fourth resistor, a first end of the fourth resistor being connected to the second path end of the sixth switch, and a second end of the fourth resistor being connected to the first connection end.

21. The battery rod of claim 15, wherein the second voltage unit comprises:
a seventh switch comprising a first path end, a second path end, and a control end, the control end of the seventh switch being connected to a second driving end of the control unit to receive a second driving signal, the second driving signal comprising a level signal, and the first path end of the seventh switch being configured to receive the battery voltage; and
a fifth resistor, a first end of the fifth resistor being connected to the second path end of the seventh switch, and a second end of the fifth resistor being connected to the first connection end.

22. The battery rod of claim 15, wherein the second voltage unit comprises:
a first comparator comprising a first input end, a second input end, and an output end, the first input end of the first comparator being configured to receive a reference voltage, and the second input end of the first comparator being connected to the first connection end;
an eighth switch comprising a first path end, a second path end, and a control end, the control end of the eighth switch being connected to the output end of the first comparator, and the first path end of the eighth switch being configured to receive the battery voltage; and
a sixth resistor, a first end of the sixth resistor being connected to the second path end of the eighth switch, and a second end of the sixth resistor being connected to the first connection end.

23. The battery rod of claim 16, further comprising:
a signal identification unit connected to a signal acquisition end of the control unit and the first connection end and configured to identify the second communication signal and feed back an identification result to the signal acquisition end.

24. The battery rod of claim 23, wherein the signal identification unit comprises:
a second comparator comprising a first input end, a second input end, and an output end, the output end of the second comparator being connected to the signal acquisition end of the control unit.

25. The battery rod of claim 23, wherein the signal identification unit comprises:
an operational amplifier comprising a first input end, a second input end, and an output end, the output end of the operational amplifier being connected to the signal acquisition end of the control unit.

26. The battery rod of claim 23, wherein the signal identification unit comprises an analog-to-digital converter, and
wherein the signal identification unit is integrated in the control unit.

27. An electronic vaporization device, comprising:
a vaporizer, wherein the vaporizer comprises the vaporizer of claim 1; and
a battery rod, comprising:
a first connection end and a second connection end, configured to be connected to the vaporizer upon insertion into the battery rod; and
a control unit connected to the first connection end and configured to send a first communication signal to the vaporizer inserted into the battery rod and receive a second communication signal from the vaporizer through the first connection end so as to implement communication between the battery rod and the vaporizer,
wherein the first communication signal comprises a first level signal serving as a logic high level and a second level signal serving as a logic low level,
wherein the second communication signal comprises a third level signal serving as a logic high level and a fourth level signal serving as a logic low level, and
wherein the second level signal and the fourth level signal are greater than a power supply voltage of an anti-counterfeiting circuit.
